(19) United States
(12) Patent Application Publication
(10) Pub. No.: US 2016/0221259 A1
(43) Pub. Date: Aug. 4, 2016

(54) TOOL PATH FOR COLOR THREE-DIMENSIONAL PRINTING

(71) Applicant: MakerBot Industries, LLC, Brooklyn, NY (US)

(72) Inventors: Michael Joseph Kobida, Lake Barrington, IL (US); Charles John Haider, St. Paul, MN (US); Cedric James Kovacs-Johnson, Wilmette, IL (US); Taylor Michael Fahey, Belle Plaine, MN (US)

(21) Appl. No.: 15/010,407

(22) Filed: Jan. 29, 2016

Related U.S. Application Data
(60) Provisional application No. 62/109,165, filed on Jan. 29, 2015.

(51) Int. Cl. B29C 67/00

(52) U.S. Cl. CPC B29C 67/0055; B29C 67/0088; B33Y 10/00

(57) ABSTRACT

A tool path for an extruder depositing build material to create a two-dimensional cross-section of a three-dimensional model of an object includes building all regions of the object's exterior surfaces having a first material characteristic (e.g., a first color), and then transitioning to another build material having a second material characteristic (e.g., a second color different than the first color) to build all regions of the object's exterior surfaces having the second material characteristic. The extruder may traverse between different exterior regions having the same material characteristic by using an optimized path directly connecting different exterior regions along interior portions of the object. In this manner, infill can be created while saving time and material. In an aspect, only when there is no path through the interior portions that directly connects different exterior regions having the same material characteristic will the extrusion of build material be paused.

### CROSS-REFERENCE TO RELATED APPLICATIONS

This application claims the benefit of U.S. Prov. App. No. 62/109,165 filed on Jan. 29, 2015, the entire content of which is incorporated herein by reference.

This application is related to U.S. patent application Ser. No. 14/589,841 filed on Jan. 5, 2015, U.S. patent application Ser. No. 14/829,023 filed on Aug. 18, 2015, and U.S. Prov. App. No. 61/941,899 filed on Feb. 19, 2014, where the entire content of each of the foregoing applications is incorporated herein by reference.

### TECHNICAL FIELD

The disclosure relates to a coloring system for use with a three-dimensional (3D) printer. The application also relates to a method for producing 3D, colored objects.

### BACKGROUND

Three-dimensional (3D) printing refers to the process of creating a 3D object through an additive process, where successive layers of material are laid down under the control of a computer. Conventionally, a three-dimensional printer can use an extrusion 3D printing process, which refers to a Fused Deposition Modeling (FDM) process, or a similar process where a build material is heated and then deposited layer by layer onto a build platform. By adding many thin layers on top of one another, sometimes hundreds or thousands, a 3D object is created.

Typically, 3D printers include at least one printer head, or extruder, containing a nozzle from which the melted build material is extruded onto the build platform to create 3D objects. The build material generally originates from an upstream feed of a raw polymer in the form of a filament or filaments. This filament(s) is fed into the upper region of the extruder as a solid, where it is then melted and deposited in its molten form from the extruder nozzle in a continuous stream.

There is a need for improved tool paths for color three-dimensional printing.

### SUMMARY

A tool path for an extruder depositing build material to create a two-dimensional cross-section of a three-dimensional model of an object includes building all regions of the object's exterior surfaces having a first material characteristic (e.g., a first color), and then transitioning to another build material having a second material characteristic (e.g., a second color different than the first color) to build all regions of the object's exterior surfaces having the second material characteristic. The extruder may traverse between different exterior regions having the same material characteristic by using an optimized path directly connecting different exterior regions along interior portions of the object. In this manner, infill can be created while saving time and material. In an aspect, only when there is no path through the interior portions that directly connects different exterior regions having the same material characteristic will the extrusion of build material be paused.

An embodiment provides a method or algorithm for dispensing pre-colored build material to create full-color 3D printed objects. Noticeable transitions from one color to the next can impact the resolution of color observed on a 3D printed model, whether the transitions are on an exterior surface or an interior surface of the model. The tool path of a 3D printer can be modified to optimize for true color in specified areas of a 3D printed model, hiding color transitions within purge areas, infill, support material, or a combination thereof. This can minimize waste, maximize speed, and produce optimal resolution. A variety of tool path methods can be implored for optimal resolution of features, additives, and/or textures that can be added to various surfaces of a 3D printed object.

In some embodiments, the 3D printer is fed a pre-colored filament. Specific extents and colors on the filament may be determined through a software program. From one color to the next, color transitions as small as about 0.001-5 cm can be observed on the filament. The tool path of the extruder of the 3D printer can be optimized to allow for the transitions between colors to occur on the interior portion (infill) of a 3D printed object, purge area, or support material, rather than the surface or other area of value within the 3D printed object. This can allow for better resolution, true color accuracy, less waste, quicker printing, and more efficiency when multiple colors and/or features and/or additives are needed per layer.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 is a block diagram of a three-dimensional printer.

FIG. 2 illustrates a filament or filaments for use with the 3D printer.

FIG. 3 illustrates post-extrusion build material.

FIG. 4 is a flow chart of a method for a 3D fabrication process.

FIG. 5 schematically illustrates a tool path of the 3D printer that is optimized according to a first method.

FIG. 6 schematically illustrates a tool path of the 3D printer that is optimized according to a second method.

FIG. 7 schematically illustrates a tool path of the 3D printer that is optimized according to a third method.

FIG. 8 schematically illustrates a tool path of the 3D printer that is optimized according to a fourth method.

FIG. 9 is a flowchart of a method for three-dimensional fabrication using an extruder.

FIG. 10 is a flowchart of a method for creating a tool path for an extruder.

FIG. 11 is a flowchart of a method for creating a tool path for an extruder

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “above,” “below,” “up,” “down,” and the like, are words of convenience and are not to be construed as limiting terms unless specifically stated.

The following description emphasizes three-dimensional printers using fused deposition modeling or similar techniques where a bead of material is extruded in a layered series of two dimensional patterns as “roads,” “paths,” or the like to form a three-dimensional object from a digital model. It will be understood, however, that numerous additive fabrication techniques are known in the art including without limitation multij et printing, stereolithography, Digital Light Processor (“DLP”) three-dimensional printing, selective laser sintering, and so forth. Such techniques may benefit from the systems and methods described below, and all such printing technologies are intended to fall within the scope of this disclosure, and within the scope of terms used herein such as “printer,” “three-dimensional printer,” “fabrication system,” and so forth, unless a more specific meaning is explicitly provided or otherwise clear from the context.

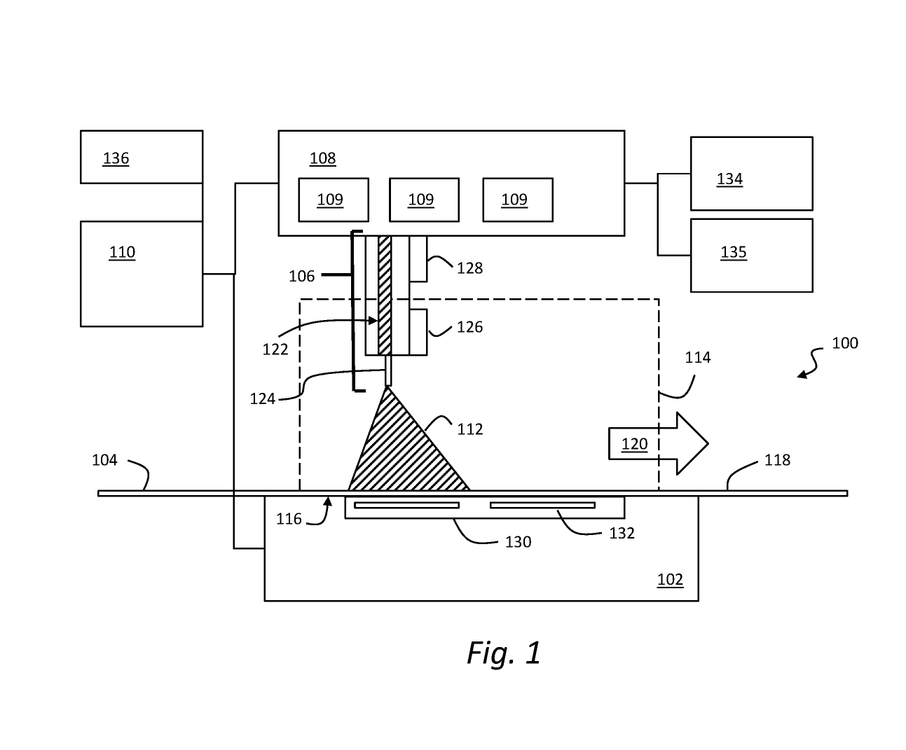

FIG. 1 is a block diagram of a three-dimensional printer. In general, the printer 100 may include a build platform 102, a conveyor 104, an extruder 106, an x-y-z positioning assembly 108, and a controller 110 that cooperate to fabricate an object 112 within a working volume 114 of the printer 100.

The build platform 102 may include a surface 116 that is rigid and substantially planar. The surface 116 may support the conveyer 104 in order to provide a fixed, dimensionally and positionally stable platform on which to build the object 112.

The build platform 102 may include a thermal element 130 that controls the temperature of the build platform 102 through one or more active devices 132 such as resistive elements that convert electrical current into heat, Peltier effect devices that can create a heating or cooling affect, or any other thermoelectric heating and/or cooling devices. Thus the thermal element 130 may be a heater that provides active heating to the build platform 102, a cooling element that provides active cooling to the build platform 102, or a combination of these. The heater 130 may be coupled in a communicating relationship with the controller 110 in order for the controller 110 to controllably impart heat to or remove heat from the surface 116 of the build platform 102. Thus, the thermal element 130 may include an active cooling element positioned within or adjacent to the build platform 102 to controllably cool the build platform 102.

It will be understood that a variety of other techniques may be employed to control a temperature of the build platform 102. For example, the build platform 102 may use a gas cooling or gas heating device such as a vacuum chamber or the like in an interior thereof, which may be quickly pressurized to heat the build platform 102 or vacated to cool the build platform 102 as desired. As another example, a stream of heated or cooled gas may be applied directly to the build platform 102 before, during, and/or after a build process. Any device or combination of devices suitable for controlling a temperature of the build platform 102 may be adapted to use as the thermal element 130 described herein.

The conveyer 104 may be formed of a sheet 118 of material that moves in a path 120 through the working volume 114. Within the working volume 114, the path 120 may pass proximal to the surface 116 of the build platform 102—that is, resting directly on or otherwise supported by the surface 116—in order to provide a rigid, positionally stable working surface for a build. It will be understood that while the path 120 is depicted as a unidirectional arrow, the path 120 may be bidirectional, such that the conveyer 104 can move in either of two opposing directions through the working volume 114. It will also be understood that the path 120 may curve in any of a variety of ways, such as by looping underneath and around the build platform 102, over and/or under rollers, or around delivery and take up spools for the sheet 118 of material. Thus, while the path 120 may be generally (but not necessarily) uniform through the working volume 114, the conveyer 104 may move in any direction suitable for moving completed items from the working volume 114. The conveyor may include a motor or other similar drive mechanism (not shown) coupled to the controller 110 to control movement of the sheet 118 of material along the path 120. Various drive mechanisms are described in further detail below.

In general, the sheet 118 may be formed of a flexible material such as a mesh material, a polyamide, a polyethylene terephthalate (commercially available in bi-axial form as MYLAR), a polyimide film (commercially available as KAPTON), or any other suitably strong polymer or other material. The sheet 118 may have a thickness of about three to about seven thousandths of an inch, or any other thickness that permits the sheet 118 to follow the path 120 of the conveyer 104. For example, with sufficiently strong material, the sheet 118 may have a thickness of about one to about three thousandths of an inch. The sheet 118 may instead be formed of sections of rigid material joined by flexible links.

A working surface of the sheet 118 (e.g., an area on the top surface of the sheet 118 within the working volume 114) may be treated in a variety of manners to assist with adhesion of build material to the surface 118 and/or removal of completed objects from the surface 118. For example, the working surface may be abraded or otherwise textured (e.g., with grooves, protrusions, and the like) to improve adhesion between the working surface and the build material.

A variety of chemical treatments may be used on the working surface of the sheet 118 of material to further facilitate build processes as described herein. For example, the chemical treatment may include a deposition of material that can be chemically removed from the conveyer 104 by use of water, solvents, or the like. This may facilitate separation of a completed object from the conveyer by dissolving the layer of chemical treatment between the object 112 and the conveyor 104. The chemical treatments may include deposition of a material that easily separates from the conveyer such as a wax, mild adhesive, or the like. The chemical treatment may include a detachable surface such as an adhesive that is sprayed on to the conveyer 104 prior to fabrication of the object 112.

In one aspect, the conveyer 104 may be formed of a sheet of disposable, one-use material that is fed from a dispenser and consumed with each successive build.

In one aspect, the conveyer 104 may include a number of different working areas with different surface treatments adapted for different build materials or processes. For example, different areas may have different textures (smooth, abraded, grooved, etc.). Different areas may be formed of different materials. Different areas may also have or receive different chemical treatments. Thus a single conveyer 104 may be used in a variety of different build processes by selecting the various working areas as needed or desired.

The extruder 106 may include a chamber 122 in an interior thereof to receive a build material. The build material may, for example, include acrylonitrile butadiene styrene (“ABS”), high-density polyethylene (“HDPL”), polylactic acid, or any other suitable plastic, thermoplastic, or other material that can usefully be extruded to form a three-dimensional object. The extruder 106 may include an extrusion tip 124 or other opening that includes an exit port with a circular, oval, slotted or other cross-sectional profile that extrudes build material in a desired cross-sectional shape.

The extruder 106 may include a heater 126 to melt thermoplastic or other meltable build materials within the chamber 122 for extrusion through an extrusion tip 124 in liquid form. While illustrated in block form, it will be understood that the heater 126 may include, e.g., coils of resistive wire wrapped about the extruder 106, one or more heating blocks with resistive elements to heat the extruder 106 with applied current, an inductive heater, or any other arrangement of heaters suitable for creating heat within the chamber 122 to melt the build material for extrusion. The extruder 106 may also or instead include a motor 128 or the like to push the build material into the chamber 122 and/or through the extrusion tip 124.

In general operation (and by way of example rather than limitation), a build material such as ABS plastic in filament form may be fed into the chamber 122 from a spool or the like by the motor 128, melted by the heater 126, and extruded from the extrusion tip 124. By controlling a rate of the motor 128, the temperature of the heater 126, and/or other process parameters, the build material may be extruded at a controlled volumetric rate. It will be understood that a variety of techniques may also or instead be employed to deliver build material at a controlled volumetric rate, which may depend upon the type of build material, the volumetric rate desired, and any other factors. All such techniques that might be suitably adapted to delivery of build material for fabrication of a three-dimensional object are intended to fall within the scope of this disclosure. Other techniques may be employed for three-dimensional printing, including extrusion-based techniques using a build material that is curable and/or a build material of sufficient viscosity to retain shape after extrusion.

The x-y-z positioning assembly 108 may generally be adapted to three-dimensionally position the extruder 106 and the extrusion tip 124 within the working volume 114. Thus by controlling the volumetric rate of delivery for the build material and the x, y, z position of the extrusion tip 124, the object 112 may be fabricated in three dimensions by depositing successive layers of material in two-dimensional patterns derived, for example, from cross-sections of a computer model or other computerized representation of the object 112. A variety of arrangements and techniques are known in the art to achieve controlled linear movement along one or more axes. The x-y-z positioning assembly 108 may, for example, include a number of stepper motors 109 to independently control a position of the extruder within the working volume along each of an x-axis, a y-axis, and a z-axis. More generally, the x-y-z positioning assembly 108 may include without limitation various combinations of stepper motors, encoded DC motors, gears, belts, pulleys, worm gears, threads, and the like. Any such arrangement suitable for controllably positioning the extruder 106 within the working volume 114 may be adapted to use with the printer 100 described herein.

By way of example and not limitation, the conveyor 104 may be affixed to a bed that provides x-y positioning within the plane of the conveyor 104, while the extruder 106 can be independently moved along a z-axis. As another example, the extruder 106 may be stationary while the conveyor 104 is x, y, and z positionable. As another example, the extruder 106 may be x, y, and z positionable while the conveyer 104 remains fixed (relative to the working volume 114). In yet another example, the conveyer 104 may, by movement of the sheet 118 of material, control movement in one axis (e.g., the y-axis), while the extruder 106 moves in the z-axis as well as one axis in the plane of the sheet 118. Thus in one aspect, the conveyor 104 may be attached to and move with at least one of an x-axis stage (that controls movement along the x-axis), a y-axis stage (that controls movement along a y-axis), and a z-axis stage (that controls movement along a z-axis) of the x-y-z positioning assembly 108. More generally, any arrangement of motors and other hardware controllable by the controller 110 may serve as the x-y-z positioning assembly 108 in the printer 100 described herein. Still more generally, while an x, y, z coordinate system serves as a convenient basis for positioning within three dimensions, any other coordinate system or combination of coordinate systems may also or instead be employed, such as a positional controller and assembly that operates according to cylindrical or spherical coordinates.

The controller 110 may be electrically coupled in a communicating relationship with the build platform 102, the conveyer 104, the x-y-z positioning assembly 108, and the other various components of the printer 100. In general, the controller 110 is operable to control the components of the printer 100, such as the build platform 102, the conveyer 104, the x-y-z positioning assembly 108, and any other components of the printer 100 described herein to fabricate the object 112 from the build material. The controller 110 may include any combination of software and/or processing circuitry suitable for controlling the various components of the printer 100 described herein including without limitation microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and the like. In one aspect, the controller 110 may include a microprocessor or other processing circuitry with sufficient computational power to provide related functions such as executing an operating system, providing a graphical user interface (e.g., to a display coupled to the controller 110 or printer 100), convert three-dimensional models into tool instructions, and operate a web server or otherwise host remote users and/or activity through the network interface 136 described below.

A variety of additional sensors may be usefully incorporated into the printer 100 described above. These are generically depicted as sensor 134 in FIG. 1, for which the positioning and mechanical/electrical interconnections with other elements of the printer 100 will depend upon the type and purpose of the sensor 134 and will be readily understood and appreciated by one of ordinary skill in the art. The sensor 134 may include a temperature sensor positioned to sense a temperature of the surface of the build platform 102. This may, for example, include a thermistor or the like embedded within or attached below the surface of the build platform 102. This may also or instead include an infrared detector or the like directed at the surface 116 of the build platform 102 or the sheet 118 of material of the conveyer 104. Other sensors that may be usefully incorporated into the printer 100 as the sensor 134 include a heat sensor, a volume flow rate sensor, a weight sensor, a sound sensor, and a light sensor. Certain more specific examples are provided below by way of example and not of limitation.

The sensor 134 may include a sensor to detect a presence (or absence) of the object 112 at a predetermined location on the conveyer 104. This may include an optical detector arranged in a beam-breaking configuration to sense the presence of the object 112 at a location such as an end of the conveyer 104. This may also or instead include an imaging device and image processing circuitry to capture an image of the working volume 114 and analyze the image to evaluate a position of the object 112. This sensor 134 may be used for example to ensure that the object 112 is removed from the conveyor 104 prior to beginning a new build at that location on the working surface such as the surface 116 of the build platform 102. Thus the sensor 134 may be used to determine whether an object is present that should not be, or to detect when an object is absent. The feedback from this sensor 134 may be used by the controller 110 to issue processing interrupts or otherwise control operation of the printer 100.

The sensor 134 may include a sensor that detects a position of the conveyer 104 along the path. This information may be obtained from an encoder in a motor that drives the conveyer 104, or using any other suitable technique such as a visual sensor and corresponding fiducials (e.g., visible patterns, holes, or areas with opaque, specular, transparent, or otherwise detectable marking) on the sheet 118.

The sensor 134 may include a heater (instead of or in addition to the thermal element 130) to heat the working volume 114 such as a radiant heater or forced hot air to maintain the object 112 at a fixed, elevated temperature throughout a build. The sensor 134 may also or instead include a cooling element to maintain the object 112 at a predetermined sub-ambient temperature throughout a build.

The sensor 134 may also or instead include at least one video camera. The video camera may generally capture images of the working volume 114, the object 112, or any other hardware associated with the printer 100. The video camera may provide a remote video feed through the network interface 136, which feed may be available to remote users through a user interface maintained by, e.g., remote hardware, or within a web page provided by a web server hosted by the three-dimensional printer 100. Thus, in one aspect there is a user interface adapted to present a video feed from at least one video camera of a three-dimensional printer to a remote user through a user interface.

The sensor 134 may include may also include more complex sensing and processing systems or subsystems, such as a three-dimensional scanner using optical techniques (e.g., stereoscopic imaging, or shape from motion imaging), structured light techniques, or any other suitable sensing and processing hardware that might extract three-dimensional information from the working volume 114. In another aspect, the sensor 134 may include a machine vision system that captures images and analyzes image content to obtain information about the status of a job, working volume 114, or an object 112 therein. The machine vision system may support a variety of imaging-based automatic inspection, process control, and/or robotic guidance functions for the three-dimensional printer 100 including without limitation pass/fail decisions, error detection (and corresponding audible or visual alerts), shape detection, position detection, orientation detection, collision avoidance, and the like.

Other components, generically depicted as other hardware 135, may also be included, such as input devices including a keyboard, touchpad, mouse, switches, dials, buttons, motion sensors, and the like, as well as output devices such as a display, a speaker or other audio transducer, light emitting diodes, and the like. Other hardware 135 may also or instead include a variety of cable connections and/or hardware adapters for connecting to, e.g., external computers, external hardware, external instrumentation or data acquisition systems, and the like.

The printer 100 may include, or be connected in a communicating relationship with, a network interface 136. The network interface 136 may include any combination of hardware and software suitable for coupling the controller 110 and other components of the printer 100 to a remote computer in a communicating relationship through a data network. By way of example and not limitation, this may include electronics for a wired or wireless Ethernet connection operating according to the IEEE 802.11 standard (or any variation thereof), or any other short or long range wireless networking components or the like. This may include hardware for short range data communications such as Bluetooth or an infrared transceiver, which may be used to couple into a local area network or the like that is in turn coupled to a data network such as the Internet. This may also or instead include hardware/software for a WiMax connection or a cellular network connection (using, e.g., CDMA, GSM, LTE, or any other suitable protocol or combination of protocols). Consistently, the controller 110 may be configured to control participation by the printer 100 in any network to which the network interface 136 is connected, such as by autonomously connecting to the network to retrieve printable content, or responding to a remote request for status or availability.

Devices, systems, and methods for tool paths for color three-dimensional printing will now be described.

The printer 100 described above with reference to FIG. 1 may be configured for a color printing process. In this manner, the build material may include a plastic build material (commonly referred to as filament or filaments) that has been pre-colored. The build material may be fed to the extruder 106 of the printer 100. The extruded colored plastic can be deposited layer by layer onto the build platform or previous layer. The resulting printed object may have an exterior surface and an interior surface. For optimal coloring, true color should be realized on the exterior surfaces while color transitions may occur on the interior surfaces of the object. Some features can also be embedded within a 3D printed object, in which unwanted material can be deposited either in a purge area, support material, or unused areas of infill. By optimizing the tool path and controlling the length and color of filament being fed to the extruder, images, textures, colors, indicia, and other types of patterns can be realized in full color on the exterior surface of the object.

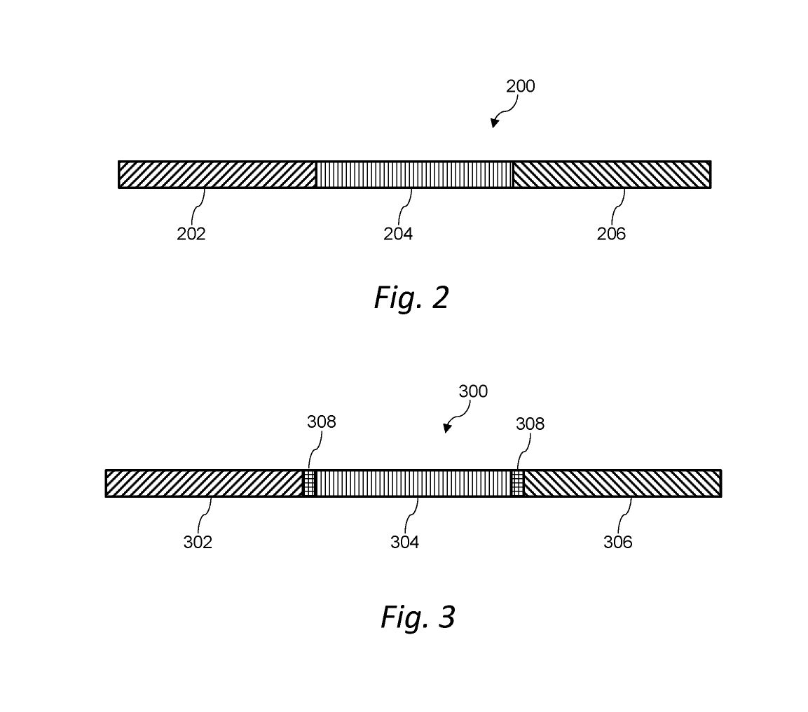

FIG. 2 illustrates a filament or filaments for use with the 3D printer. Specifically, FIG. 2 illustrates a length of the build material, i.e., a filament 200, in more detail. The illustrated filament 200 includes sections having different colors. For example, the first section 202 may be a first color (e.g., blue), the second section 204 may be a second color (e.g., red), and the third section 206 may be a third color (e.g., green). The colors may be applied to an interior surface or an exterior surface of the filament 200. A system and method for making a filament having sections or lengths of different colors is described in U.S. patent application Ser. No. 14/589,841, filed Jan. 5, 2015, the entire content of which is hereby incorporated by reference herein.

FIG. 3 illustrates post-extrusion build material. That is, once the pre-extruded material shown in FIG. 2 is placed through an extruder, a post-extrusion filament 300 can be created. The sections 302, 304, 306 may be the same colors as the corresponding sections 202, 204, 206 in FIG. 2, with the difference between sections 202, 204, 206 are pre-extruded colored material and sections 302, 304, 306 are post-extruded colored material. During the extrusion process, transitions regions 308 may develop between the sections 302, 304, 306.

Each transition region 308 may be generally a combination of the color upstream from the region 308 and the color downstream from the region 308. The transition regions 308 may be relatively small (e.g., between about 0.001 mm and 5 cm along the length of the filament 300). During the 3D printing process, the locations and sizes of the transition regions 308 can be tracked by a processor controlling the 3D printer. In some embodiments, the expected size of each transition region 308 can be programmed into the printer by a user based on, for example, past experience. In other embodiments, the size of each transition region 308 can be monitored and determined by the printer using a sensor (e.g., a light sensor, a camera, etc.).

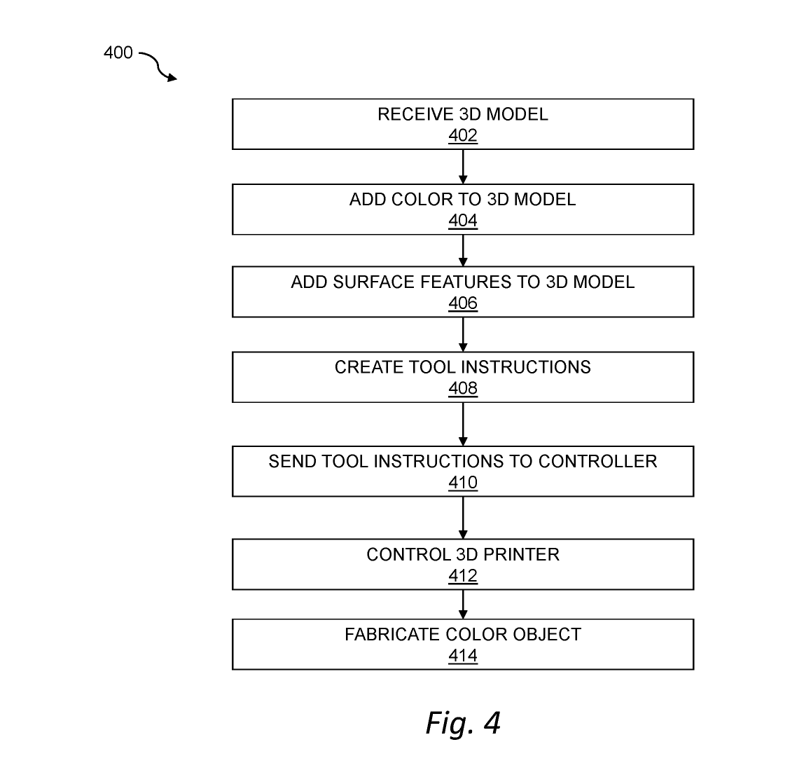

FIG. 4 is a flow chart of a method for a 3D fabrication process. The method 400 may use strategically colored build materials to achieve full-color features on a 3D printed object and hide transitions between colors either within the object and/or in a separate purge area with the use of one extruder or a combination of extruders.

As shown in step 402, the method 400 may include receiving a 3D model. The 3D model can be downloaded, constructed with modeling software, and/or scanned and imported. These 3D models come in a variety of file types including but not limited to .stl, .obj, and/or .amf formats. The model may be provided to a computer, which may be any general purpose or special purpose computing device including, e.g., a processor, memory, and one or more data or network interfaces or other input/output ports. This may include processing circuitry on a printer and/or a separate computer or any combination of these.

As shown in step 404, the method 400 may include adding color to the 3D model. With a computer program, features, such as color or any other sort of additive and/or feature, can be selectively placed on the 3D model in the format of print by print, part by part, layer by layer, and/or voxel by voxel feature(s). These features can be incorporated on the surface of the object or on the interior. Textures and bit maps are another method for adding features to a 3D model. The computer may convert the model in accordance with computer code running on the computer to obtain a representation of the model suitable for fabrication. In one aspect, this may include multiple steps such as conversion to a standard format such as the widely used stereolithography (STL) file format. As shown in step 408, the method 400 may include creating tool instructions for printing the 3D model.

As shown in step 406, the method 400 may include adding surface features to the 3D model. Exterior/interior surface features include, but are not limited to color. Other features include conductivity, thermal properties, magnetic properties, and many others. These features can be added into a computer program. The model may include, or may be processed to derive, one or more surface and/or exterior and/or interior features of the object, or a user may specify such features independently from the object described by the model. However derived, these features may be used by the computer in preparing tool instructions. This may include incorporating the features into the line model or tool path where appropriate, or creating metadata for the tool instructions so that the controller can apply the features consistent with its own capabilities. However, features below the processing resolution (which may be measured using any suitable metric such as a minimum feature dimension, a minimum tool path step, a minimum volume of build material, a minimum x-y resolution, and so forth) may still be reproduced by the fabrication platform using the techniques discussed herein. In particular, the controller may identify surfaces of the model, identify one or more corresponding surface features (which may be location dependent or location independent), and modify the tool instructions during fabrication to obtain the desired surface features on a physical model fabricated from the model.

The features may include any of a variety of structures, features, or the like. In one aspect, the features may provide a general description of color such as cyan, magenta, yellow and black, and so forth, along with an identification of where on a surface of the object the surface feature appears. The surface feature may be physically modeled as a bit map or voxel representation, or as a more general representation that can be scaled, rotated, or otherwise modified to achieve a desired feature or texture. In one aspect, a variety of surface textures or features may be provided for selection and placement by a user. More generally, a variety of types of surface features, and representations of same, may be suitably adapted to the uses contemplated herein. In some embodiments, the tool instructions may include information allowing for later calculation of surface features by a controller. This information may, without limitation, include surface identifiers relating lines in a tool path to surfaces in the model, such as exterior surfaces, interior surfaces, and so on. The information may also or instead include texture identifiers that identify surface features with reference to base textures, texture models, texturing parameters (magnitude, rotation, scaling, etc.), and so forth. This information may further include data used in texture mapping the base textures to the surfaces (e.g., data for registering/orienting the texture map to the surface, and so on). In embodiments, the texture maps may include two-dimensional texture maps, three-dimensional texture maps, tessellations, smoothing or antialiasing patterns/filters, and so on.

It will be understood that the surface texture may be included within object data for the model, or may be inferred from the model itself, all without departing from the scope of this disclosure. Regardless of how or where obtained, the surface feature may be realized in a physical object fabricated by a three-dimensional printer or the like.

As shown in step 410, the method 400 may include sending the tool instructions to a controller for a 3D printer. The model, or the standard format representation of the model, may be further processed to obtain tool instructions for a controller such as the controller described below. In one aspect, the tool instructions may include G-code or any other computer numerical control (CNC) programming language or other description suitable for execution by the controller. In one aspect, G-code or other similar tool instructions may include a tool path that characterizes a physical path in three-dimensional space traversed by a tool such as the x-y-z positioning assembly and extruder described above. A tool may extrude material while traversing a portion of the tool path in order to form a physical object. The tool instructions may represent this tool path as a sequence of directions, a sequence of locations, a sequence of starting and ending locations, or any other suitable representation.

However formulated, the tool instructions may be transmitted to the controller for execution.

As shown in step 412, the method 400 may include controlling the 3D printer to fabricate the color object. When surface texture information is available, either within the tool instructions or independent of the tool instructions, the controller may adjust or adapt the tool instructions accordingly to achieve the intended surface texture, such as moving the tool path from the surface of the object to the interior to transition from one color to the next. It should be appreciated that the terms computer and controller may refer to separate processing devices such as a computer coupled to a printer and an on-board processor of a printer, however this architecture is not required, and various steps described herein may suitably be performed by one or the other of these devices, or some combination of these and/or any other processors or other processing circuitry. Thus, while it is generally true that a fabrication process can logically be divided into steps performed prior to physical fabrication and steps performed during physical fabrication, no specific allocation of specific hardware to specific steps is intended by the foregoing description.

Logic for calculating color extents and deposition timing and placement during a fabrication process may be implemented in firmware, software, hardware, or the like on the controller.

In general, the data structure may include a description of an object that has been preprocessed for rendering as a continuous path in a deposition process based upon, e.g., an extrusion at a constant deposition rate, along with a surface definition of one or more surface features for the object. The description of the object may include any of a variety of tool instructions that specify parameters such as temperature, feed motor speed, and any other controllable parameters for a fabrication platform such as the printer described above. The instructions may more particularly include a tool path including a number of start and end coordinates in x-y-z space that characterize a path traversed by a tool such as an extruder during fabrication of the object. Typically, the z coordinate remains constant while a two-dimensional line is rendered in the x-y plane, however, any combination or sequence of coordinates within the processing capability of the fabrication platform may be used to define a tool path for rendering an object as contemplated herein. Techniques are well known in the art for converting a three-dimensional object model into a tool path that includes sequential layers of two-dimensional patterns.

In addition, the description of the object may include a surface identifier or other metadata that flags a particular line or line segment in the tool path as belonging to an exterior wall. It should be noted that this data is optional. Rather than explicitly labeling surfaces, exterior surfaces and the like may be inferred by a controller that receives the description of the object based on, e.g., analysis of the tool path or a comparison of the tool path to an original digital model from which the tool path was obtained.

The surface definition may define surface features or surface texture in any suitable manner. For example, the surface definition may be indexed to the surface identifier of the description of the object so that textures or features can be retrieved and applied on a segment-by-segment basis along the tool path. The texture identifier may include a reference to a texture description, such as a mathematical or physical (e.g., bitmapped) representation of a texture, or to one or more tool instructions that vary a deposition rate to achieve a desired feature or texture. In another aspect, the surface definition may be omitted as an explicit description of surface features or textures, and a controller or the like processing the tool path may instead compare the tool path to a source digital model of the object to determine whether and where a deposition rate might be varied to conform the fabrication process to features of the digital model. It will further be appreciated that both of these techniques may be applied in combination, either concurrently or sequentially, without departing from the scope of this disclosure.

To obtain a 3D printed object with the desired features, an optimal tool path may be determined and constructed. This tool path can allow for maximum speed, minimal waste, efficiency and feature realization on the 3D printed object. There are a variety of methods that can be implored but are unique to current processes. These methods use the known locations and sizes of the transition regions 308 on the filament 300 (see FIG. 3) to help determine the optimal tool path.

As shown in step 414, the method 400 may include fabricating the color object.

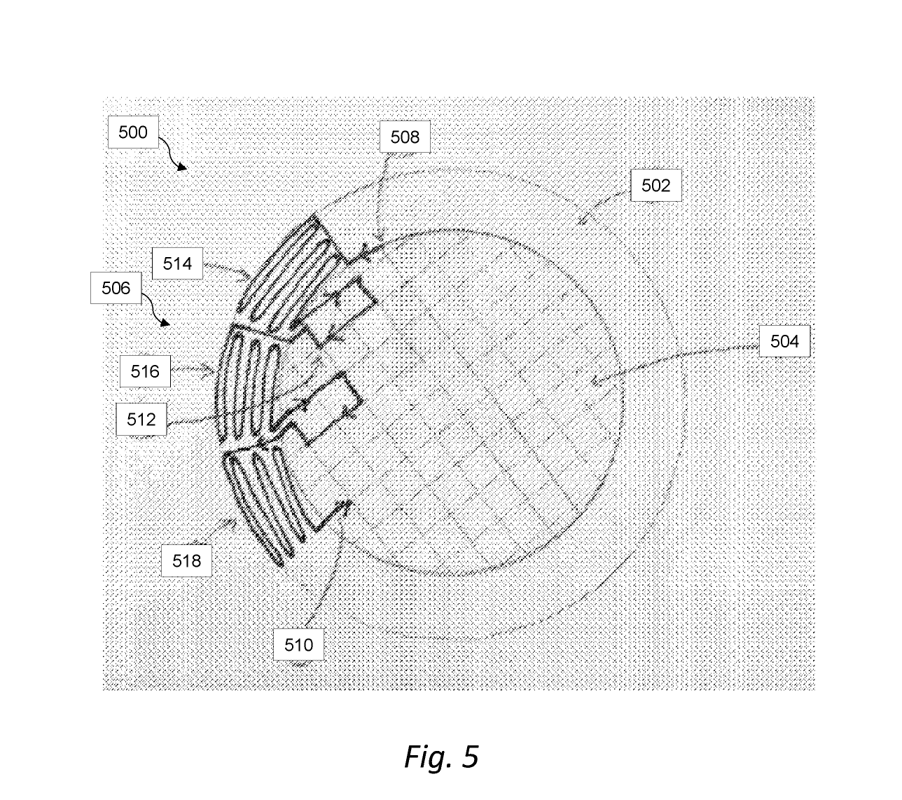

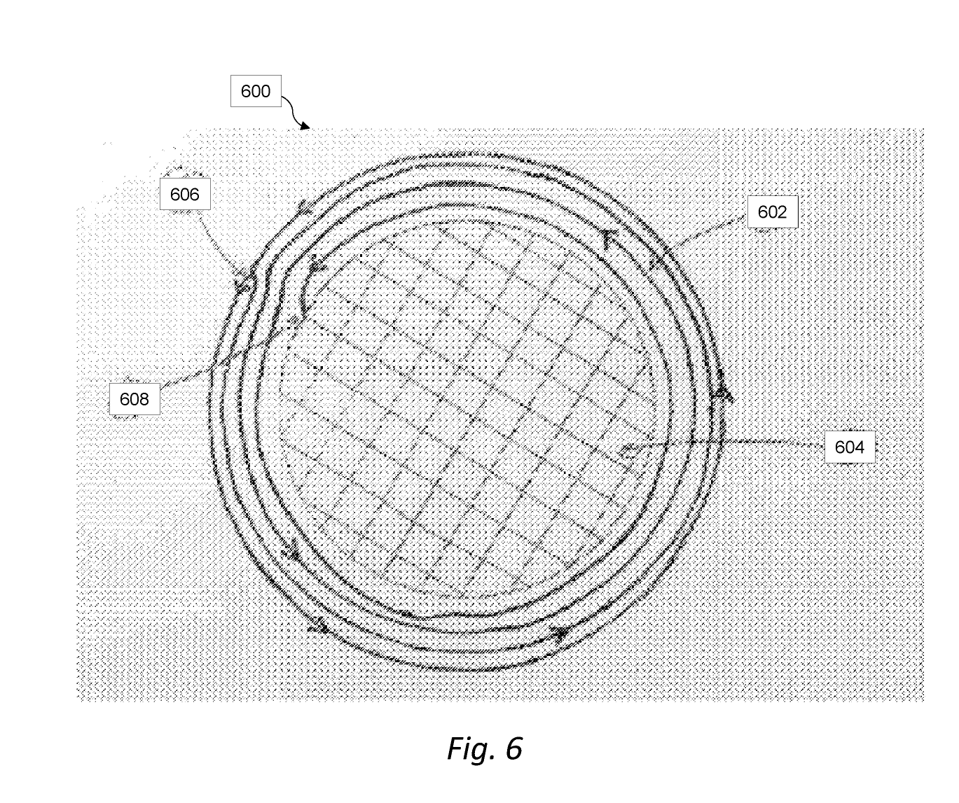

FIG. 5 schematically illustrates a tool path of the 3D printer that is optimized according to a first method. As shown in the figure, the features of the model and location of these features may be used to create a tool path for the extruder of the 3D printer for creating an object 500. The exterior surface 502 and interior surface 504 of the model may be identified. The exterior surface 502 of an object may be defined as the about 0.01-10 mm shell. The remaining inner core of the object may be identified as the interior surface 504. These interior and exterior surfaces 502, 504 can both contain various features. The surface characteristics of the model's features may be used to generate extents of color and extrusion distances for each extent. As mentioned above, the transition from color to color can happen over a distance of about 0.001-5.0 cm of extruded filament. In order to make sure that there is no visible blending of colors on the exterior surface 502 or any other desired location of the 3D printed object 500, the tool path 506 of the print head may be optimized (e.g., from a starting point 508 to an ending point 510) for color transitions 512 to occur within the interior surface 504 of the object 500 or other portions of the model with less desirable aesthetic features to ensure that the anticipated color can be realized on the surface (e.g., 514, 516, and 518) or desired location. The interior surface 504 of the object 500 may be comprised of transition material as well as traditional infill, or the infill may be comprised of the transition material. The object 500 shown in FIG. 5 may be separated into layers (e.g., as described above), and a tool path can be generated for each layer.

FIG. 6 schematically illustrates a tool path of the 3D printer that is optimized according to a second method. As shown in FIG. 6, the features of the model and location of these features are used to create a tool path for the extruder of the 3D printer for creating an object 600. The exterior surface 602 and interior surface 604 of the model may be identified. The exterior surface 602 of the object 600 may be defined as the about 0.01-10 mm shell. The remaining inner core of the object 600 may be identified as the interior surface 604. These interior and exterior surfaces 602, 604 can both contain various features. The surface characteristics of the model's features may be used to generate extents of color and extrusion distances for each extent. Assuming there are no color transitions observed (e.g., transition regions can be eliminated), a color surface can be printed in full color continuously (e.g., from a start point 606 to an endpoint 608) until the surface is complete then the infill can be created. This can also be performed where the interior surface 604 is fabricated first then the exterior surface 602 then the infill or an order thereof. The object shown in the figure may be separated into layers, and a tool path can be generated for each layer.

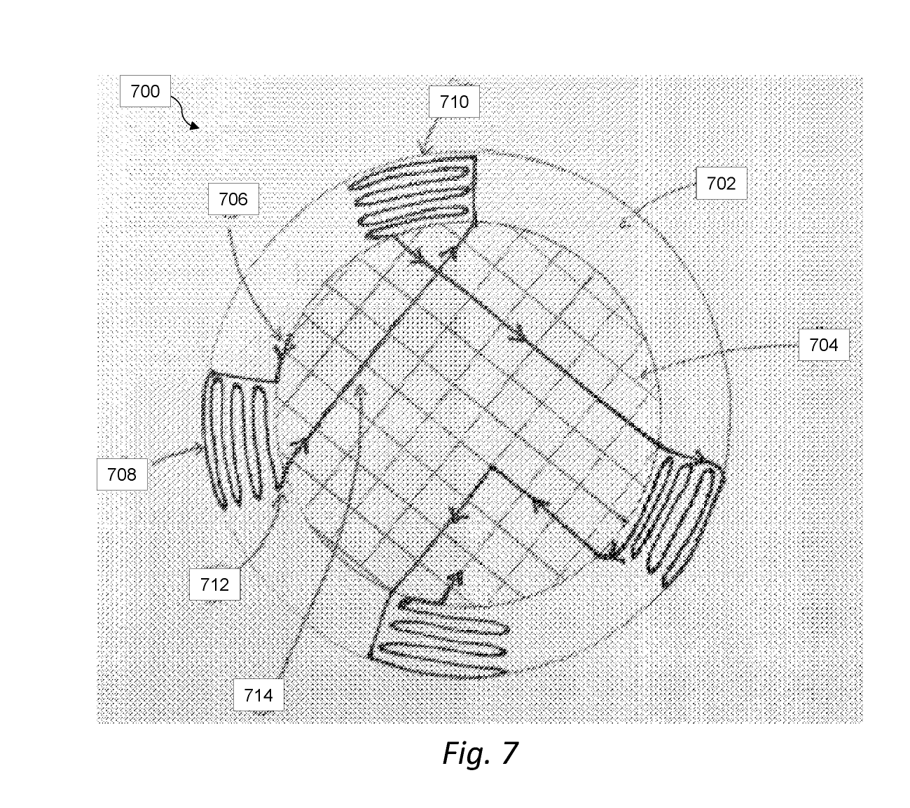

FIG. 7 schematically illustrates a tool path of the 3D printer that is optimized according to a third method. As shown in the figure, the features of the model and location of these features are then used to create a tool path for the extruder of the 3D printer for creating an object 700. The exterior surface 702 and interior surface 704 of the model may be identified. The exterior surface 702 of the object 700 may be defined as the about 0.01-10 mm shell. The remaining inner core of the object 700 may be identified as the interior surface 704. These interior and exterior surfaces 702, 704 can both contain various features. The surface characteristics of the model's features may be used to generate extents of color and extrusion distances for each extent. As mentioned above, the transition from color to color can happen over a distance of 0.001-5.0 cm of extruded filament. The technique shown in FIG. 7 may focus on spot coloring, in which for each layer, the number and lengths of colors get measured and organized for minimal color transitions per layer. The starting point 706 of the tool path can begin either in the interior surface 704 or on the exterior surface 702. When there are multiple spots for the same color on a particular layer, the tool path may advance from a first surface region 708 to a second surface region 710, using the interior positions 712, 714 to minimize waste and hide color when moving tool path positions. This may require the tool path to lift up and move to another surface or use the interior to deposit the infill and move to the other surface. Once one color is complete, the next color may be chosen and executed in a similar fashion until all colors are complete for a layer. The object 700 may be separated into layers, and a tool path can be generated for each layer.

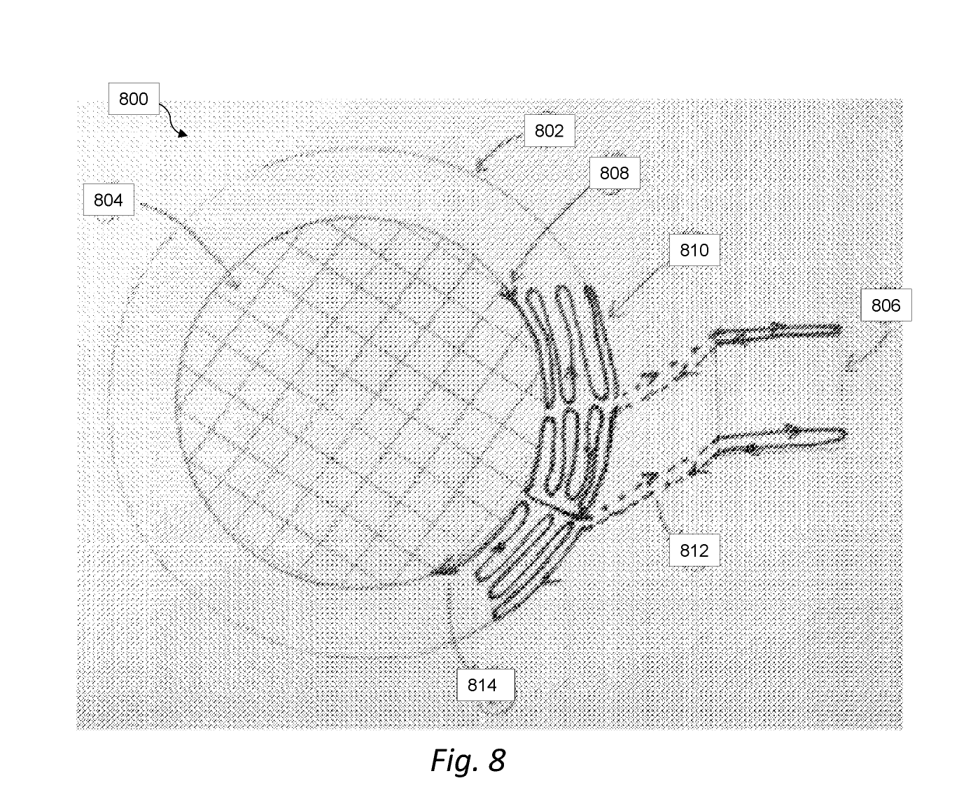

FIG. 8 schematically illustrates a tool path of the 3D printer that is optimized according to a fourth method. As shown in the figure, the features of the model and location of these features are then used to create a tool path for the extruder of the 3D printer for creating an object 800. The exterior surface 802 and interior surface 804 of the model may be identified. The exterior surface 802 of the object 800 may be defined as the about 0.01-10 mm shell. The remaining inner core of the object 800 may be identified as the interior surface 804. These interior and exterior surfaces 802, 804 can both contain various features. The surface characteristics of the model's features may be used to generate extents of color and extrusion distances for each extent. As mentioned above, the transition from color to color can happen over a distance of about 0.001-5.0 cm of extruded filament. In order to move the color transitions out of the model, a purge station 806, be it an object on the build platform or apart of the 3D printer, can be implemented. The starting point 808 of the tool path can be structured for the color to be realized on the surface 810 of the object 800, then during transitions, the tool path moves to the purge area 806, deposits transition material, and returns via a return path 812 to the 3D printed object to continue printing the surface in color. Once the surface is complete the infill can be completed or vice versa, i.e., after the endpoint 814 of the surface tool path.

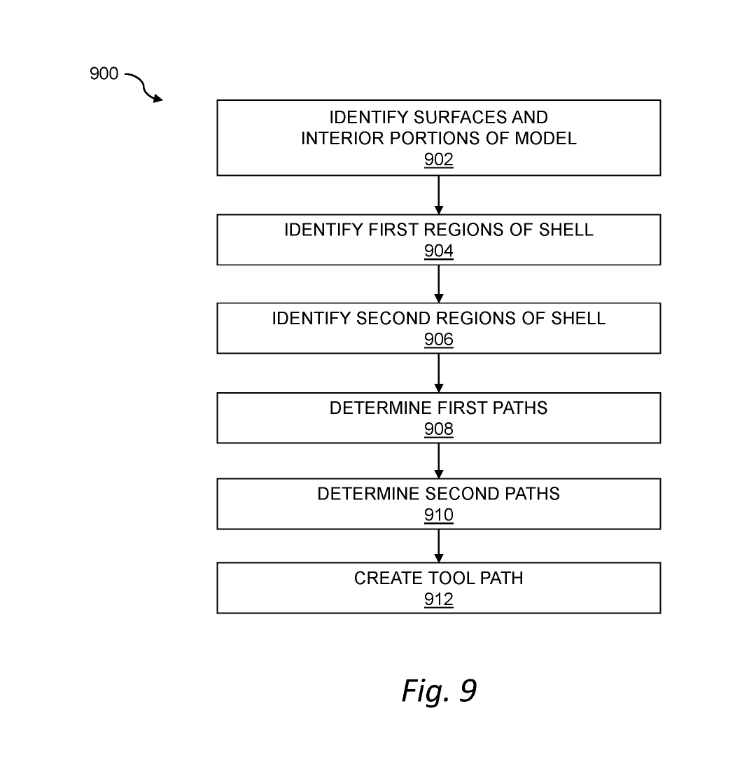

FIG. 9 is a flowchart of a method for three-dimensional fabrication using an extruder.

As shown in step 902, the method 900 may include identifying one or more exterior surfaces and one or more interior portions of a two-dimensional cross-section of a three-dimensional model of an object. The one or more exterior surfaces may form a shell of the object. The one or more interior portions may be at least partially bounded by the shell.

As shown in step 904, the method 900 may include identifying a plurality of first regions of the shell including a first material characteristic. Each of the plurality of first regions may be isolated from one another along the shell.

As shown in step 906, the method 900 may include identifying a plurality of second regions of the shell including a second material characteristic. Each of the plurality of second regions may be isolated from one another along the shell.

In an aspect, the first material characteristic is a first color, and the second material characteristic is a second color different from the first color. In another aspect, the first material characteristic is a first structural property, and the second material characteristic is a second structural property different from the first structural property. Implementations may also or instead include an aspect where the first material characteristic is a first aesthetic property other than color, and the second material characteristic is a second aesthetic property other than color different from the first aesthetic property.

As shown in step 908, the method 900 may include determining a plurality of first paths between the plurality of first regions of the shell along the two-dimensional cross-section. Each of the plurality of first paths may directly connect different first regions along the one or more interior portions. The first paths may be selected to minimize distances between different first regions.

As shown in step 910, the method 900 may include determining a plurality of second paths between the plurality of second regions of the shell along the two-dimensional cross-section. Each of the plurality of second paths may directly connect different second regions along the one or more interior portions. The second paths may be selected to minimize distances between different second regions.

As shown in step 912, the method 900 may include creating a tool path for the extruder to fabricate the two-dimensional cross-section.

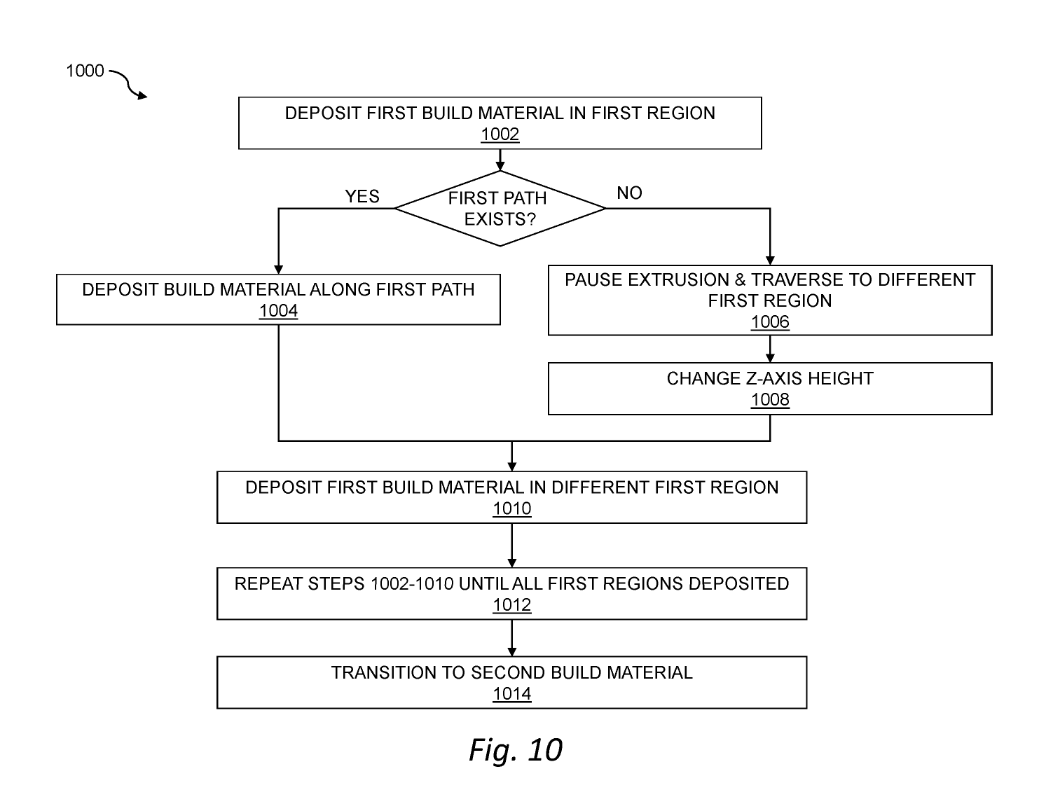

FIG. 10 is a flowchart of a method for creating a tool path for an extruder. The method 1000 may be a continuation of the method 900 shown in FIG. 9.

As shown in step 1002, the method 1000 may include depositing a first build material having the first material characteristic in one of the plurality of first regions of the shell.

As shown in step 1004, the method 1000 may include, when a first path exists between the one of the plurality of first regions of the shell and a different first region, depositing the first build material along the first path.

As shown in step 1006, the method 1000 may include, when no first path exists, pausing extrusion of the first material while the extruder traverses to the different first region.

As shown in step 1008, the method 1000 may include changing a z-axis height of the extruder for traversing between different first regions when no first path exists.

As shown in step 1010, the method 1000 may include depositing the first build material in the different first region.

As shown in step 1012, the method 1000 may include repeating steps 1002-1010 until all first regions of the shell in the two-dimensional cross-section are deposited.

As shown in step 1014, the method 1000 may include transitioning from the first build material to a second build material having the second material characteristic. Transitioning from the first build material to the second build material may occur in the one or more interior portions. For example, transitioning from the first build material to the second build material may occur within one or more voids disposed in-between lengths of infill within the one or more interior portions.

In another aspect, transitioning from the first build material to the second build material occurs in an excursion from the two-dimensional cross-section. The excursion from the two-dimensional cross-section may include traversing the extruder to a purge area or the like.

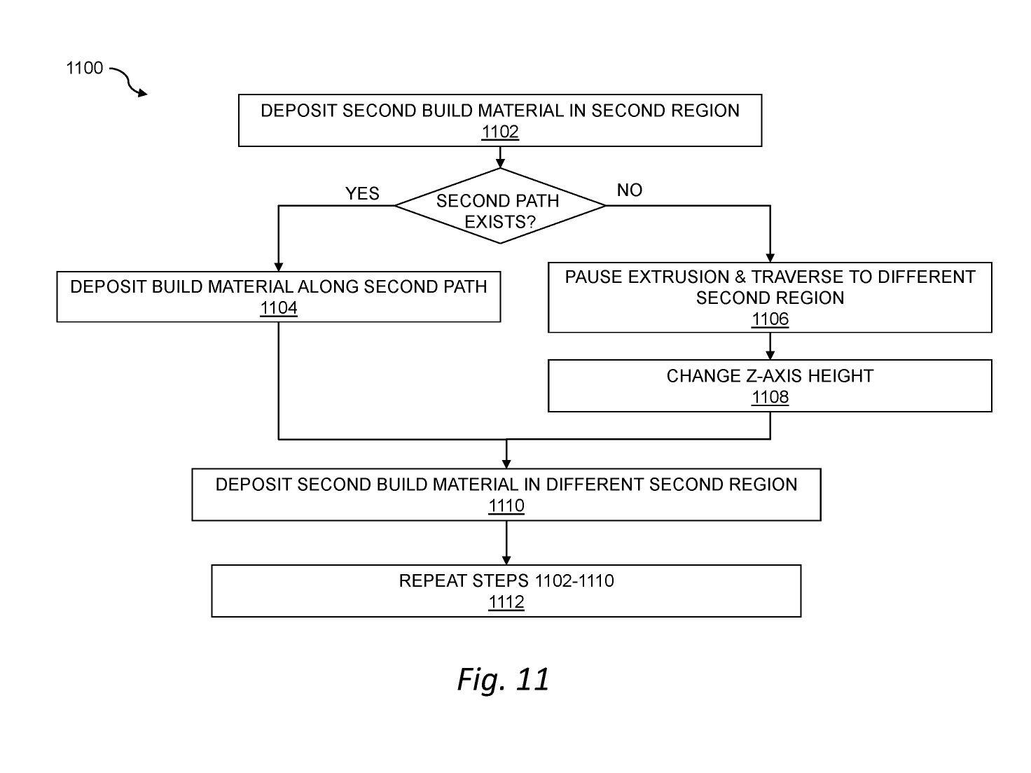

FIG. 11 is a flowchart of a method for creating a tool path for an extruder. The method 1100 may be a continuation of the method 1000 shown in FIG. 10.

As shown in step 1102, the method 1100 may include depositing the second build material in one of the plurality of second regions of the shell.

As shown in step 1104, the method 1100 may include, when a second path exists between the one of the plurality of second regions of the shell and a different second region, depositing the second build material along the second path.

As shown in step 1106, the method 1100 may include, when no second path exists, pausing extrusion of the second material while the extruder traverses to the different second region.

As shown in step 1108, the method 1100 may include changing a z-axis height of the extruder for traversing between different second regions when no second path exists.

As shown in step 1110, the method 1100 may include depositing the second build material in the different second region.

As shown in step 1112, the method 1100 may include repeating steps 1102-1110 until all second regions of the shell in the two-dimensional cross-section are deposited.

The methods 900, 1000, and 1100 (or any other methods described herein) may be performed using a computer program product comprising non-transitory computer-executable code embodied in a non-transitory computer readable medium that, when executing on one or more computing devices, performs the steps of the methods.

During these methods, a tolerance can be built into every color extent to account for any errors during the process (e.g., poor flow, skipping in the stepper motors, miscalculations, etc.). This tolerance can be about +/−5% of the axial color length on the pre-extruded filament and/or filaments. Assuming a reasonable number of colors per layer, this tolerance can allow a buffer between colors to ensure small errors in calculation or operation of the 3D printer do not have a significant impact on the overall construction of the full color 3D printed object. Transitions may be unaffected, but a calculation can be done to determine the amount of infill, purge, and/or support material needed. This infill calculation can rely on the number of colors per layer, tolerance range, and amount of infill/purge/support material desired. Depending on the results, the infill can be used for all transition material or just some transition material, where the rest could be purged else on the 3D printed or as part of support material.

During these methods, an encoder or the like may be implemented in addition to or in lieu of building in a tolerance for the expected length of filament to the actual length of filament being fed into the extruder. In this manner, the encoder may track the length of filament such that the actual length (and hence volume) of filament being fed into the extruder is known. Information from the encoder may be used in creating the tool instructions in an implementation.

Implementations may include a process for coloring a filament of build material upstream from an extruder of a three-dimensional printer. The process for coloring the filament may be configured to assist in any of the devices, systems, and methods described herein. For example, in an aspect, the filament may be colored based on the tool instructions created in the methods described above, i.e., to help minimize the transitions between different colors. In other words, the filament may be colored upstream of the extruder using the tool paths from the tool instructions, where lengths of filament are determined (using the tool instructions) to be deposited in certain regions of an object being fabricated (e.g., in an exterior region on the object's surface, or in an interior region of the object). Then, the colored filament may be extruded and deposited as a layer. In this manner, the filament may be deposited in an ideal configuration/pattern/path. Thus, in an aspect, instead of switching between filaments when creating a multi-colored object, the filament is pre-colored. In addition, the toolpaths described herein can be utilized, thereby creating opportunities for highly optimized fabrication of a colored object.

The tool path instructions discussed herein may be sent to a controller. This controller can send coloring directions, including timing, color, and extent to the coloring device. The controller can send tool path information to the X, Y, and Z positioning system and build plate.

The controller, which may receive the tool instructions as a stream of instructions or as a file for local execution or in any other suitable form, may interpret the tool instructions and generate control outputs directing the various aspects of a fabrication system, e.g., the printer described with reference to FIG. 1, to produce a 3D object described in the model. The control outputs may include analog control outputs, digital control outputs, or the like.

Each of the color-application and feed assemblies described herein may also include a controller, a power supply, a user interface, a communications interface, and a motor.

The controller or processor may be part of, or connected to, an external device (e.g., a computer or the like). The controller (or computer) may include combinations of software and hardware that are operable to, inter alia, control the operation of the color-application, feed assembly, control the speed at which the filament is pulled from a supply, and control color applied to the filament. In one implementation, the controller includes a printed circuit board (PCB) that is populated with a plurality of electrical and electronic components that provide power, operational control, and protection to any power distribution devices. In implementations, the PCB includes, e.g., a processing unit (e.g., a microprocessor, a microcontroller, or another suitable programmable device), a memory, and a bus. The bus can connect various components of the PCB, e.g., the memory to the processing unit. The memory may include, for example, a read-only memory (ROM), a random access memory (RAM), an electrically erasable programmable read-only memory (EEPROM), a flash memory, a hard disk, or another suitable magnetic, optical, physical, or electronic memory device. The processing unit may be connected to the memory. The processor may execute software that is capable of being stored in the RAM (e.g., during execution), the ROM (e.g., on a generally permanent basis), or another non-transitory computer readable medium such as another memory or a disc. The memory may be included in the processing unit. The controller may also include an input/output (I/O) that includes routines for transferring information between components within the controller and other components of the color-application assembly or the 3D printer. For example, the communication module may be configured to provide communication between the color-application and feed assembly and one or more devices in the 3D printer.

Software included in some implementations is stored in the memory of the controller. The software may include, e.g., firmware, applications, program data, program modules, and other executable instructions. The controller may be configured to retrieve from the memory and execute instructions related to the control processes and methods described herein. For example, the controller may be configured to execute instructions retrieved from the memory for determining which color to apply to the filament based on data received in data packets from an external source or from the memory. In implementations, the controller includes additional, fewer, or different components.

The PCB may also include a plurality of additional passive and active components such as resistors, capacitors, inductors, integrated circuits, and amplifiers. These components may be arranged and connected to provide a plurality of electrical functions to the PCB including filtering, signal conditioning, or voltage regulation. For descriptive purposes, the PCB and the electrical components populated on the PCB may be collectively referred to as the controller.

The power supply may supply a nominal AC or DC voltage to any components described herein. The power supply may be powered by main power having nominal line voltages between, for example, 100V and 240V AC and frequencies of approximately 50-60 Hz. The power supply may also be configured to supply lower voltages to operate circuits and components within the color-application and feed assembly. In implementations, the power distribution device is powered by one or more batteries or battery packs.

The user interface may be included to control the color-application and feed assembly or the operation of the 3D printer as a whole. The user interface may be operably coupled to the controller to control, for example, the color applied to the filament portions. The user interface can include any combination of digital and analog input devices required to achieve a desired level of control for the system. For example, the user interface can include a computer having a display and input devices, a touch-screen display, a plurality of knobs, dials, switches, buttons, faders, or the like. In some implementations, the user interface is separated from the color application and feed assembly.

The communications interface may send and/or receives signals to and/or from one or more separate communication modules. Signals may include, among other components, information, data, serial data, and data packets. The communications interface can be coupled to one or more separate communication modules via wires, fiber, and/or a wirelessly. Communication via wires and/or fiber can be any appropriate network topology known to those skilled in the art, such as Ethernet. Wireless communication can be any appropriate wireless network topology known to those skilled in the art, such as Wi-Fi.

The motor may include, among other components, one or more motor devices. The one or more motor devices may be configured to receive signals from the controller and pull the filament portions through the color-application assembly. In some implementations, the one or more motor devices are stepper motors.

The controller may also be coupled to the motor assemblies of the color applicators. In some implementations, the controller transmits signals to the motor assemblies, which cause the assemblies to move the color applicators. For example, based on a desired color for a particular layer or portion of a 3D printed object, the controller can actuate the motor assemblies at suitable times to color the filament so that portions of the filament being used to form the particular layer or portion are the proper color. Since the controller, color-application unit, and 3D printer may function as a single system, the controller may know how far the colored filament will travel before the filament will actually be used by the printer. The controller may account for this lag time to appropriately color the filament. Furthermore, the controller can continuously actuate and de-actuate the motor assemblies to apply different colors to different sections of the filament. For example, the controller can actuate the assemblies to color a first section (e.g., 10 cm length) of the filament a first color (e.g., red), color a second section (e.g., a 20 cm length) of the filament a second color (e.g., blue), and color a third section (e.g., a 15 cm length) of the filament a third color (e.g., white). The amount and type of color applied to the filament can be programmed into the controller by a user, or can be automatically determined by the controller based on desired colors identified in, for example, a CAD model.

The coloring device assembly may include a color-application unit that is positioned upstream of the 3D printer. The color-application unit may be configured to receive a filament or filaments, and direct the filament(s) to the printer head of the 3D printer. The assembly may also include a color applicator coupled to the color-application unit. The color applicator may be operable to selectively apply color to a filament or filaments.

Another embodiment includes a method for preparing a filament or filaments for use with a printer head of a 3D printer. The method may include receiving the filament at a color-application unit positioned upstream of the 3D printer. The method may also include applying color, by a color applicator coupled to the color-application unit, to a filament or filaments. The method may further include directing the filament or filaments from the color application unit to the printer head of the 3D printer.

The X, Y, and Z positioning unit may move the extruder head from coordinate to coordinate. In general, the printer may include a build platform, an extruder, an x-y-z positioning assembly, and a controller that cooperate to fabricate an object within a working volume of the printer.

The extruder may include a chamber in an interior thereof to receive a build material. The build material may, for example, include acrylonitrile butadiene styrene (“ABS”), high-density polyethylene (“HDPL”), polylactic acid (“PLA”), or any other suitable plastic, thermoplastic, or other material that can usefully be extruded to form a three-dimensional object. The extruder may include an extrusion tip or other opening that includes an exit port with a circular, oval, slotted or other cross-sectional profile that extrudes build material in a desired cross-sectional shape.

The extruder may include a heater to melt thermoplastic or other meltable build materials within the chamber for extrusion through an extrusion tip in liquid form. It will be understood that the heater may include, e.g., coils of resistive wire wrapped about the extruder, one or more heating blocks with resistive elements to heat the extruder with applied current, an inductive heater, or any other arrangement of heating elements suitable for creating heat within the chamber sufficient to melt the build material for extrusion. The extruder may also or instead include a motor or the like to push the build material into the chamber and/or through the extrusion tip.

In general operation (and by way of example rather than limitation), a build material such as ABS plastic in filament form may be fed into the chamber from a spool or the like by the motor, melted by the heater, and extruded from the extrusion tip. By controlling a rate of the motor, the temperature of the heater, and/or other process parameters, the build material may be extruded at a controlled volumetric rate. It will be understood that a variety of techniques may also or instead be employed to deliver build material at a controlled volumetric rate, which may depend upon the type of build material, the volumetric rate desired, and any other factors. All such techniques that might be suitably adapted to delivery of build material for fabrication of a three-dimensional object are intended to fall within the scope of this disclosure.

The x-y-z positioning assembly may generally be adapted to three-dimensionally position the extruder and the extrusion tip within the working volume. Thus by controlling the volumetric rate of delivery for the build material and the x, y, z position of the extrusion tip, the object may be fabricated in three dimensions by depositing successive layers of material in two-dimensional patterns derived, for example, from cross-sections of a computer model or other computerized representation of the object. A variety of arrangements and techniques are known in the art to achieve controlled linear movement along one or more axes. The x-y-z positioning assembly may, for example, include a number of stepper motors to independently control a position of the extruder within the working volume along each of an x-axis, a y-axis, and a z-axis. More generally, the x-y-z positioning assembly may include without limitation various combinations of stepper motors, encoded DC motors, gears, belts, pulleys, worm gears, threads, and so forth. For example, in one aspect the build platform may be coupled to one or more threaded rods by worm gears so that the threaded rods can be rotated to provide z-axis positioning of the build platform relative to the extruder. This arrangement may advantageously simplify design and improve accuracy by permitting an x-y positioning mechanism for the extruder to be fixed relative to a build volume. Any such arrangement suitable for controllably positioning the extruder within the working volume may be suitably adapted to use with the printer described herein.

In general, this may include moving the extruder, or moving the build platform, or some combination of these. Thus it will be appreciated that any reference to moving an extruder relative to a build platform, working volume, or object, is intended to include movement of the extruder or movement of the build platform, or both, unless a more specific meaning is explicitly provided or otherwise clear from the context. Still more generally, while an x, y, z coordinate system serves as a convenient basis for positioning within three dimensions, any other coordinate system or combination of coordinate systems may also or instead be employed, such as a positional controller and assembly that operates according to cylindrical or spherical coordinates.

The build plate may support the 3D printed object as it is built up layer by layer. The build platform may include a surface that is rigid and substantially planar. The surface may provide a fixed, dimensionally, and positionally stable platform on which to build the object. The build platform may include a thermal element that controls the temperature of the build platform through one or more active devices, such as resistive elements that convert electrical current into heat, Peltier effect devices that can create a heating or cooling effect, or any other thermoelectric heating and/or cooling devices. The thermal element may be coupled in a communicating relationship with the controller in order for the controller to controllably impart heat to or remove heat from the surface of the build platform.

The above systems, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionality may be integrated into a dedicated, standalone device. All such permutations and combinations are intended to fall within the scope of the present disclosure.

Embodiments disclosed herein may include computer program products comprising computer-executable code or computer-usable code that, when executing on one or more computing devices, performs any and/or all of the steps of the control systems described above. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the control systems described above may be embodied in any suitable transmission or propagation medium carrying computer-executable code and/or any inputs or outputs from same.

It will be appreciated that the devices, systems, and methods described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A method for three-dimensional fabrication using an extruder, the method comprising:
identifying one or more exterior surfaces and one or more interior portions of a two-dimensional cross-section of a three-dimensional model of an object, the one or more exterior surfaces forming a shell of the object, the one or more interior portions at least partially bounded by the shell;
identifying a plurality of first regions of the shell including a first material characteristic, each of the plurality of first regions isolated from one another along the shell;
identifying a plurality of second regions of the shell including a second material characteristic, each of the plurality of second regions isolated from one another along the shell;
determining a plurality of first paths between the plurality of first regions of the shell along the two-dimensional cross-section, each of the plurality of first paths directly connecting different first regions along the one or more interior portions;
determining a plurality of second paths between the plurality of second regions of the shell along the two-dimensional cross-section, each of the plurality of second paths directly connecting different second regions along the one or more interior portions; and
creating a tool path for the extruder to fabricate the two-dimensional cross-section, the tool path comprising:
(i) depositing a first build material having the first material characteristic in one of the plurality of first regions of the shell;
(ii) when a first path exists between the one of the plurality of first regions of the shell and a different first region, depositing the first build material along the first path;
(iii) when no first path exists, pausing extrusion of the first material while the extruder traverses to the different first region;
(iv) depositing the first build material in the different first region;
(v) repeating steps (i)-(iv) until all first regions of the shell in the two-dimensional cross-section are deposited;
(vi) transitioning from the first build material to a second build material having the second material characteristic;
(vii) depositing the second build material in one of the plurality of second regions of the shell;
(viii) when a second path exists between the one of the plurality of second regions of the shell and a different second region, depositing the second build material along the second path;
(ix) when no second path exists, pausing extrusion of the second material while the extruder traverses to the different second region;
(x) depositing the second build material in the different second region; and
(xi) repeating steps (vii)-(x) until all second regions of the shell in the two-dimensional cross-section are deposited.

2. The method of claim 1 wherein the first material characteristic is a first color, and the second material characteristic is a second color different from the first color.

3. The method of claim 1 wherein transitioning from the first build material to the second build material occurs in the one or more interior portions.

4. The method of claim 3 wherein transitioning from the first build material to the second build material occurs within one or more voids disposed in-between lengths of infill within the one or more interior portions.

5. The method of claim 1 wherein transitioning from the first build material to the second build material occurs in an excursion from the two-dimensional cross-section.

6. The method of claim 5 wherein the excursion from the two-dimensional cross-section includes traversing the extruder to a purge area.

7. The method of claim 1 further comprising changing a z-axis height of the extruder for traversing between different first regions when no first path exists.

8. The method of claim 1 wherein the first paths are selected to minimize distances between different first regions.

9. The method of claim 1 wherein the second paths are selected to minimize distances between different second regions.

10. The method of claim 1 wherein the first material characteristic is a first structural property, and the second material characteristic is a second structural property different from the first structural property.

11. The method of claim 1 wherein the first material characteristic is a first aesthetic property other than color, and the second material characteristic is a second aesthetic property other than color different from the first aesthetic property.

12. A computer program product comprising non-transitory computer-executable code embodied in a non-transitory computer readable medium that, when executing on one or more computing devices, performs the steps of:
identifying one or more exterior surfaces and one or more interior portions of a two-dimensional cross-section of a three-dimensional model of an object, the one or more exterior surfaces forming a shell of the object, the one or more interior portions at least partially bounded by the shell;
identifying a plurality of first regions of the shell including a first material characteristic, each of the plurality of first regions isolated from one another along the shell;
identifying a plurality of second regions of the shell including a second material characteristic, each of the plurality of second regions isolated from one another along the shell;
determining a plurality of first paths between the plurality of first regions of the shell along the two-dimensional cross-section, each of the plurality of first paths directly connecting different first regions along the one or more interior portions;
determining a plurality of second paths between the plurality of second regions of the shell along the two-dimensional cross-section, each of the plurality of second paths directly connecting different second regions along the one or more interior portions; and
creating a tool path for an extruder of a three-dimensional printer to fabricate the two-dimensional cross-section, the tool path comprising:
(i) depositing a first build material having the first material characteristic in one of the plurality of first regions of the shell;
(ii) when a first path exists between the one of the plurality of first regions of the shell and a different first region, depositing the first build material along the first path;
(iii) when no first path exists, pausing extrusion of the first material while the extruder traverses to the different first region;
(iv) depositing the first build material in the different first region;
(v) repeating steps (i)-(iv) until all first regions of the shell in the two-dimensional cross-section are deposited;
(vi) transitioning from the first build material to a second build material having the second material characteristic;
(vii) depositing the second build material in one of the plurality of second regions of the shell;
(viii) when a second path exists between the one of the plurality of second regions of the shell and a different second region, depositing the second build material along the second path;
(ix) when no second path exists, pausing extrusion of the second material while the extruder traverses to the different second region;
(x) depositing the second build material in the different second region; and
(xi) repeating steps (vii)-(x) until all second regions of the shell in the two-dimensional cross-section are deposited.

13. The computer program product of claim 12 wherein the first material characteristic is a first color, and the second material characteristic is a second color different from the first color.

14. The computer program product of claim 12 wherein transitioning from the first build material to the second build material occurs in the one or more interior portions.

15. The computer program product of claim 12 wherein transitioning from the first build material to the second build material occurs in an excursion from the two-dimensional cross-section.

16. The computer program product of claim 15 wherein the excursion from the two-dimensional cross-section includes traversing the extruder to a purge area.

17. The computer program product of claim 12 further comprising code that performs the step of changing a z-axis height of the extruder for traversing between different first regions when no first path exists.

18. The computer program product of claim 12 wherein the first paths are selected to minimize distances between different first regions, and wherein the second paths are selected to minimize distances between different second regions.

19. The computer program product of claim 12 wherein the first material characteristic is a first structural property, and the second material characteristic is a second structural property different from the first structural property.

20. The computer program product of claim 12 wherein the first material characteristic is a first aesthetic property other than color, and the second material characteristic is a second aesthetic property other than color different from the first aesthetic property.
